(19) United States
(12) Patent Application Publication
(10) Pub. No.: US 2014/0032341 A1
(43) Pub. Date: Jan. 30, 2014

(54) FASTFOODLANE

(71) Applicants: RAGHURAM BALASUBRAMANIAN, Orange, CA (US); Michael Oh, Santa Ana, CA (US)

(72) Inventors: RAGHURAM BALASUBRAMANIAN, Orange, CA (US); Michael Oh, Santa Ana, CA (US)

(21) Appl. No.: 13/560,880

(22) Filed: Jul. 27, 2012

(51) Int. Cl. G06Q 30/06; G06Q 50/12

(52) U.S. Cl. CPC G06Q 30/0633; G06Q 50/12
USPC 705/15

(57) ABSTRACT

The present invention is an interactive food ordering and payment system for allowing interactive communication between a client side and a server side via an Internet enabled vehicle associated with a customer, and via an Internet enabled point of sale terminal associated with a service provider. The system comprising an Internet enabled application for user interface, the application comprising a means for allowing at least one user to search for at least one proximate restaurant, select from menu options, order and pay for the selections online. The system further comprising a means for allowing at least one service provider to retrieve customer orders pending to be filled, a means for monitoring the length of time an order has been pending, a means for tracking order status, sorting and filtering orders, and a means for compiling performance statistics.

### BACKGROUND OF THE DISCLOSURE

1. Technical Field of the Embodiment

The present embodiment relates in general to a system and method for online fast food ordering. More specifically, the present embodiment relates to a system and method for fast food ordering via a net enabled motor vehicle.

2. Description of the Related Art

Restaurants are intended to serve food to customers satisfying their requirements in a clean and tidy environment. Emerging use of the Internet allows customers to conveniently access areas such as online banking, online purchasing, online learning classes, etc. In order to better serve their customers, restaurants have introduced food ordering online. An online food ordering system allows the customers to place their orders more conveniently from home or in transit, and can also be used to place reservations. Customer can search for a favorite restaurant, choose from available items, and choose delivery or pick-up. Payment can be done by credit card, debit card or cash.

Most of the online food ordering systems utilize software service whereby restaurants purchase database and software from the company and manage the online ordering themselves. Another option is a Net-based service whereby restaurants sign contracts with an online food ordering website that may handle orders from many restaurants in a regional or national area.

Conventional systems for online food ordering have considerable drawbacks. For example, an existing system includes a comprehensive, unique, and novel mobile phone and online based ordering and reservation system. The Internet server receives requests and data from both end consumers and/or business owners individually, processes requests and prepares necessary information from the data base, and then sends the corresponding message back to either the end consumers or the business owners, or individually or both, on as needed or as requested basis. However, the system employs mobile phones for instantly sending and receiving messages which may not be delivered due to network problems in some situations causing an inconvenience to the customer and a loss of business to the restaurant.

A variant to this system used by some restaurants requires the restaurants to register with a third party online food ordering system. The present invention describes a system and method for an online food ordering infrastructure wherein a server includes a data storage device with menu information concerning each participating restaurant stored therein and, as consideration for a fixed registration fee, each restaurant receives a merchant account associated with a unique account key for direct payment thereto. However, this system limits the customers to utilize the service offered by participating restaurants only.

Hence, it can be seen, that there is a need for a system that would provide an online food ordering system integrated in a net enabled motor vehicle. Such a system would provide safe online payment and ease of use to the customers. This needed system would efficiently save time and provide convenience for customers. Moreover, the system can be implemented on smart phones, tablets, or a home-based computer.

### SUMMARY OF THE DISCLOSURE

The present invention is an interactive food ordering and payment system for allowing interactive communication between a client side and a server side. The system comprises an Internet enabled application for user interface via a net enabled motor vehicle associated with a customer, and an Internet enabled application for user interface via a net enabled point of sale terminal associated with a service provider.

The application comprising: a means for allowing at least one customer to log-on to the application which permits the at least one customer to enter a username and a password, a means for displaying at least one restaurant proximate and/or within a range to a current customer location, at least one means for ordering at least one item from an available menu options, a means for selecting a payment mode from a plurality of payment options and a means for submitting the payment mode and displaying an order code for purchasing the selected item. The user interface allows the at least one customer to search for the at least one restaurant, select from the available menu options, order the at least one item and pay for the at least one item through online.

The at least one means of ordering the item includes a touch screen ordering and a voice based ordering. The login page includes a first box to enter a username and a second box to enter a password. At least one customer having an account can access the Internet enabled application by entering the username and the password and the at least one customer can press the log in button to access the internet enabled application. At least one new customer can create an account by using a “Create an account button”. Activating a “Remember me” button will automatically save the username and the password and the at least one customer can automatically log on to the account. When the at least one customer logs on to the Internet enabled application, a welcoming message for greeting the at least one customer is displayed on a screen of at least one in-car computing electronic device integrated into an Internet enabled motor vehicle.

Another embodiment provides a system wherein the Internet enabled application may be operated by a customer on at least one electronic device selected from a group consisting of smart phones, tablets and other mobile devices.

The at least one customer can select at least one restaurant from the list of at least one restaurant displayed on the screen. Also the at least one customer will have the option to search for at least one restaurant proximate and/or within a range to a current customer location. Driving direction of the at least one restaurant near to the current location of the at least one customer is displayed on the screen. The driving direction helps the at least one customer to easily find the position of the at least one restaurant.

The name, location and address of at least one restaurant selected by the at least one customer is displayed on the screen. The at least one customer is able to know the distance of the at least one restaurant from the current location. A place order button is employed to navigate to an order page and a get direction button to redirect to the driving direction. The customer can select at least one item from an available menu options and can add the at least one selected item and cancel if not needed. After selecting the at least one item the at least one customer can confirm the order by selecting an order complete button and cancel the order by selecting a cancel button. The at least one customer has the option to view Previous orders and to add favorite items to Favorites. The customer can select a payment mode from the plurality of payment options. The mode of payment of the at least one item can be selected from a group consisting of credit card, debit card or cash the payment mode selected by the at least one customer. A submit button is present to submit the payment for the ordered item. An order code for purchasing the at least one item selected by the at least one customer is displayed on the screen.

All of the option buttons displayed on the screen are large enough in size to allow for ease of view and safety of the at least one customer operating the Internet enabled motor vehicle.

The application comprising: a means for allowing at least one service provider to log-on to the application via a point of sale terminal. The application permits the at least one service provider to enter a username and a password, a means for displaying pending orders to be filled, completed orders, and a means for compiling performance statistics. The login page includes a first box to enter a username and a second box to enter a password. At least one service provider having an account can access the Internet enabled application by entering the username and the password and the at least one service provider can press the Submit button to access the Internet enabled application. At least one new service provider employee can create an account by using a “Create an account” button. Activating a “Remember me on this computer” button will automatically save the username and the password and the at least one service provider can automatically log on to the account.

When the at least one service provider logs on to the application a welcome page. The at least one service provider can select to view and update status of pending orders, view and search for completed orders, or compile and view analytics.

At the pending orders page the at least one service provider will be able to view order number, items ordered, order submission time, and length of the order has been pending. The at least one service provider selects the ready button when the order is ready to be picked up. When the order has been picked up the at least one service provider selects the complete button to update the status.

At the completed orders page, the at least one service provider will be able to view order numbers, order date, time received, time completed, items ordered, and total order amount. The completed orders page also includes a search box and search button which allows the at least one service provider to search for specific orders.

The analytics page allows the at least one service provider with the ability to compile performance statistics by tracking average time to complete orders, average time for orders to be ready, canceled orders, and amount of orders in a day.

### BRIEF DESCRIPTION OF THE DRAWINGS

FIGS. 1A through 1L show various steps involved in customer ordering and payment of food through an Internet enabled application;

FIG. 2 shows a flow chart describing the method of ordering and payment of food through the Internet enabled application;

FIG. 3A illustrates a point of sale terminal displaying a login page of the Internet enabled application associated with a service provider;

FIG. 3B illustrates a point of sale terminal displaying a home page of the Internet enabled application associated with a service provider;

FIG. 3C illustrates a point of sale terminal displaying a pending orders page of the Internet enabled application associated with a service provider; and

FIG. 3D illustrates a point of sale terminal displaying a completed orders page of the Internet enabled application associated with a service provider;

### DETAILED DESRIPTION OF THE DRAWINGS

In the following discussion that addresses a number of embodiments and applications of the present invention, reference is made to the accompanying drawings that form a part hereof, and in which is shown by way of illustration specific embodiments in which the invention may be practiced. It is to be understood that other embodiments may be utilized and changes may be made without departing from the scope of the present invention.

Various inventive features are described below that can each be used independently of one another or in combination with other features. However, any single inventive feature may not address any of the problems discussed above or only address one of the problems discussed above. Further, one or more of the problems discussed above may not be fully addressed by any of the features described below.

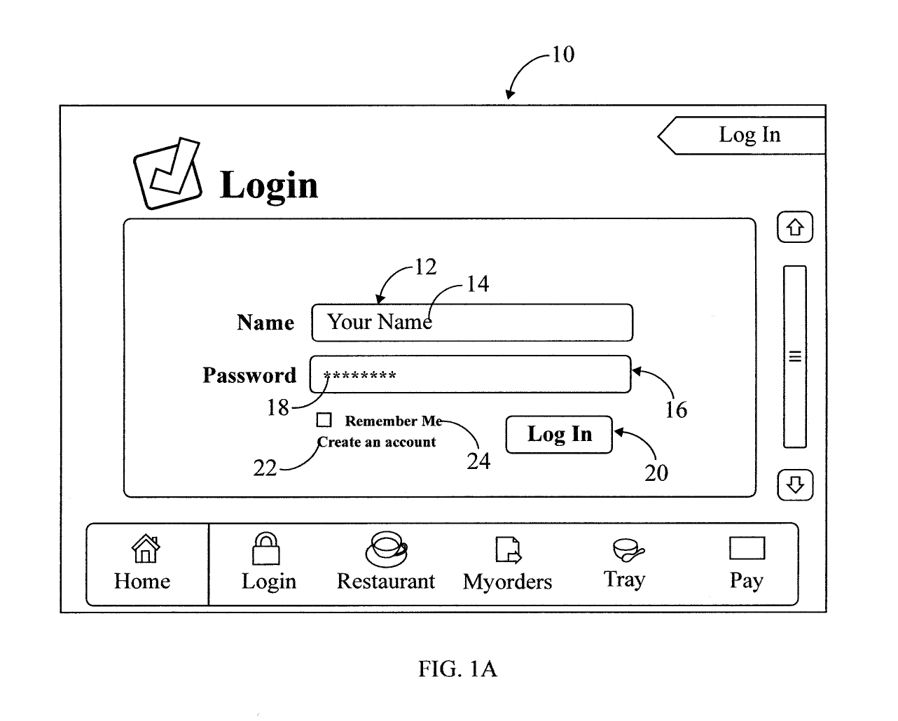

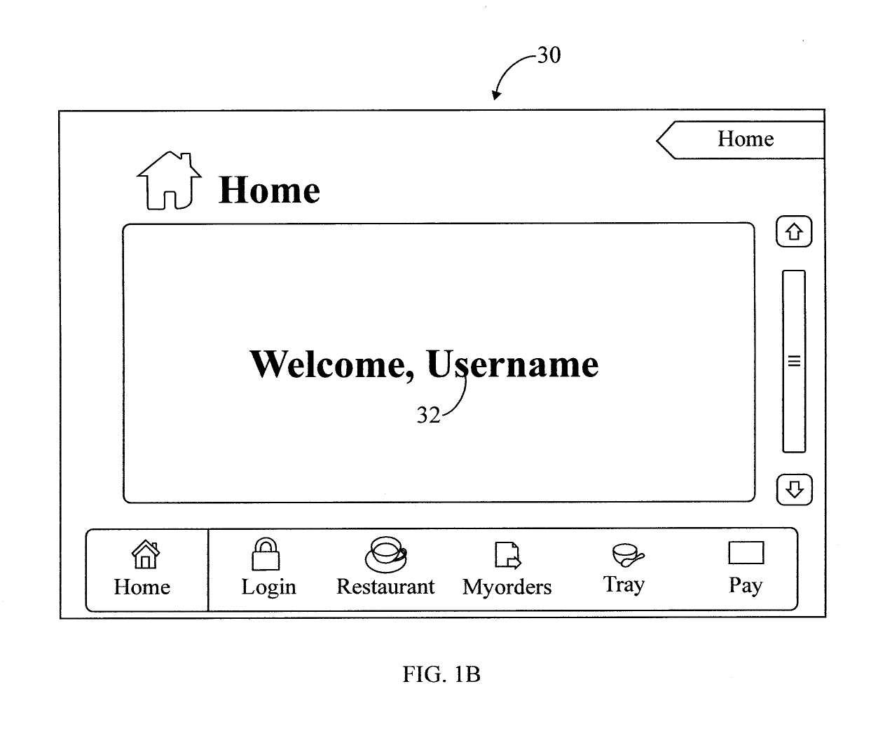

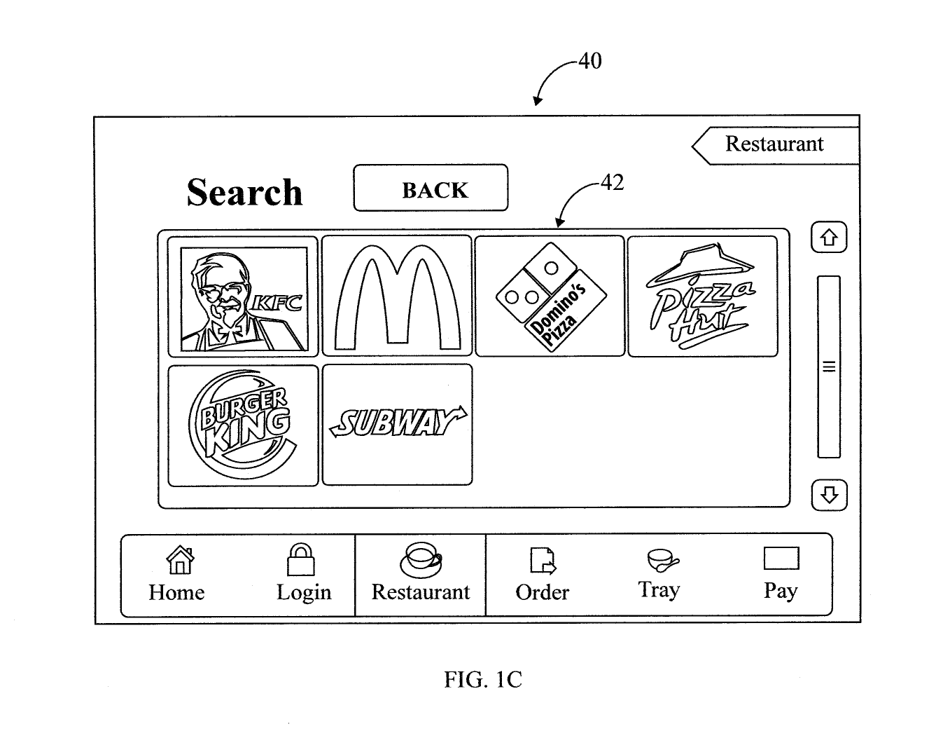

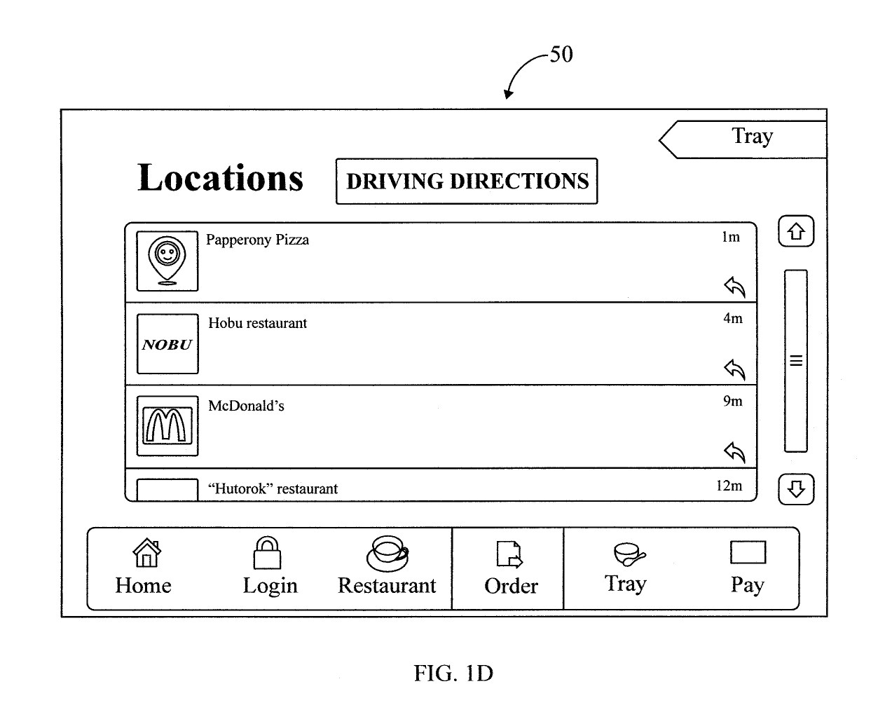

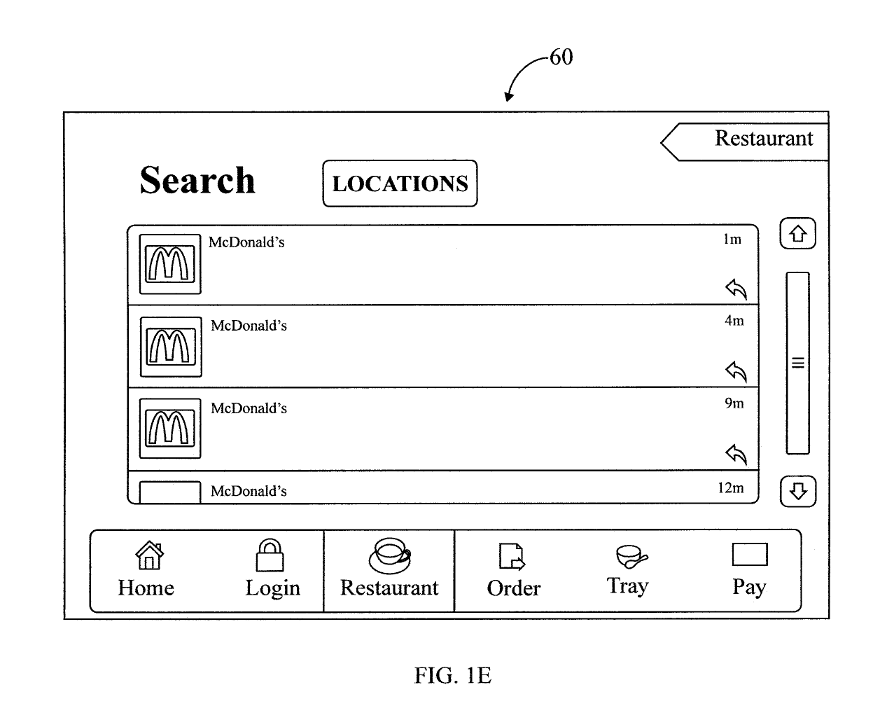

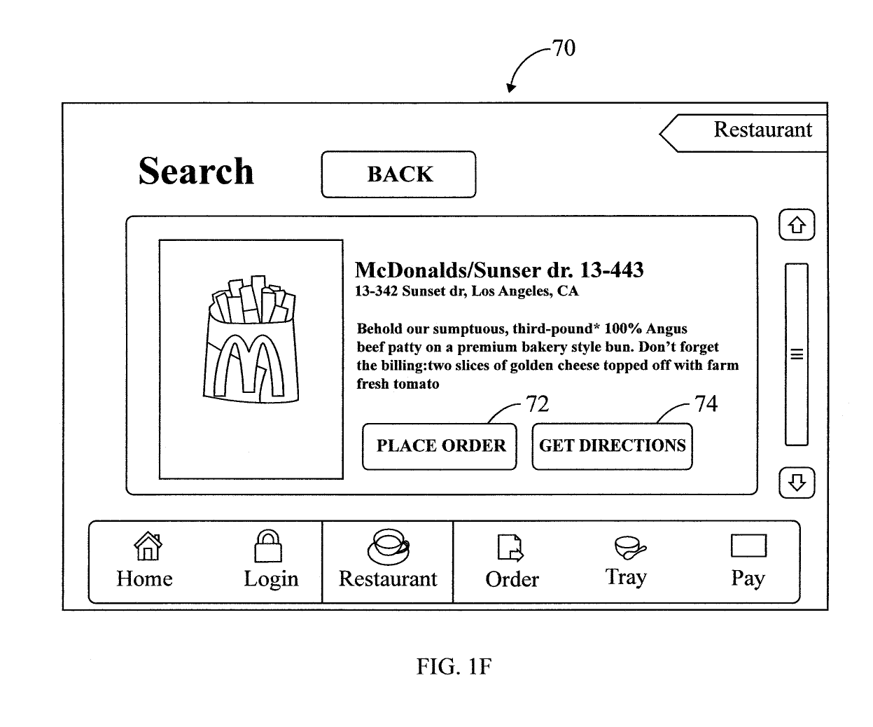

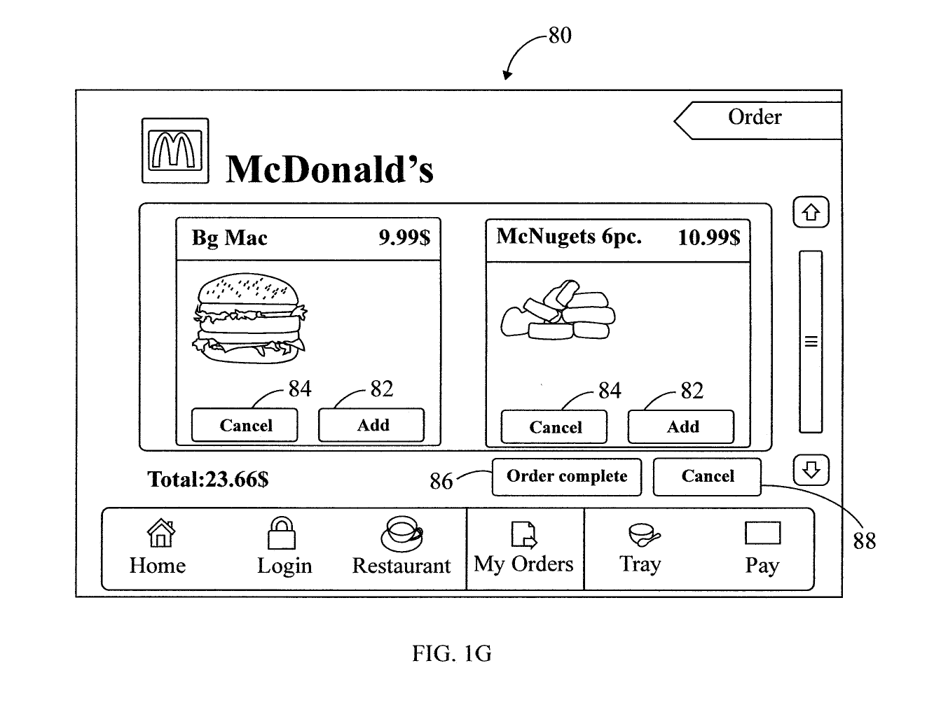

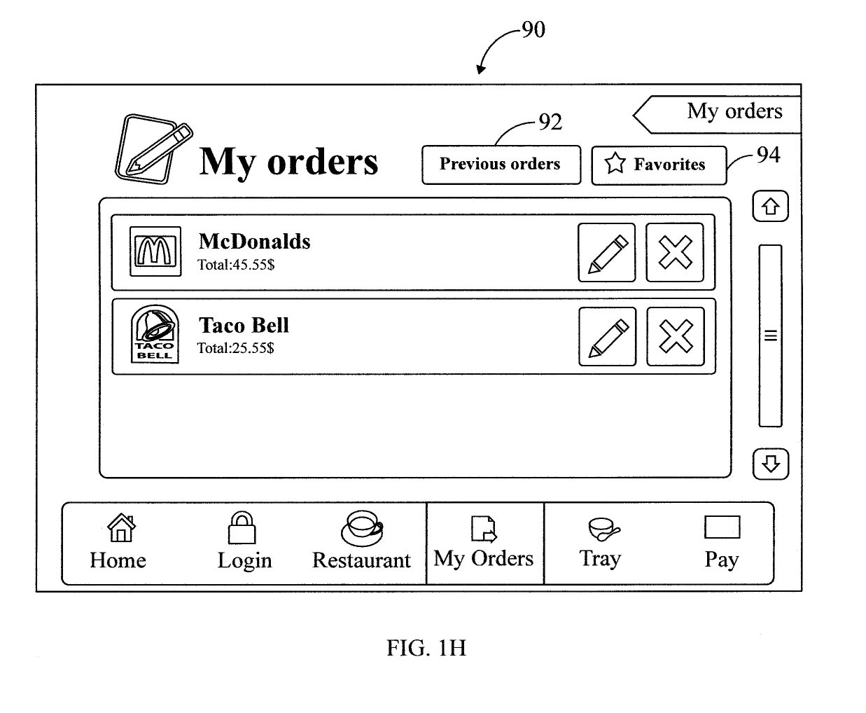

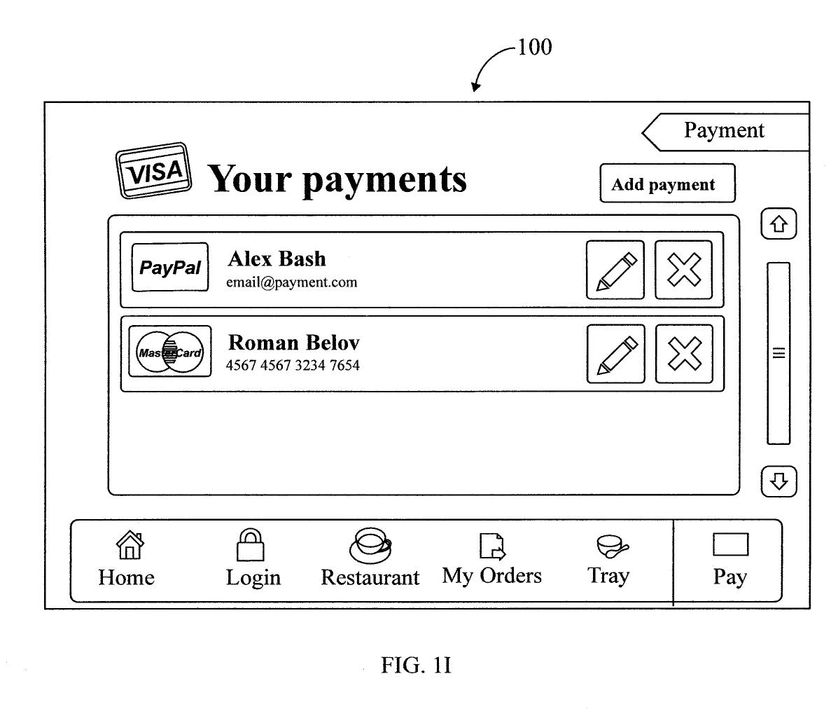

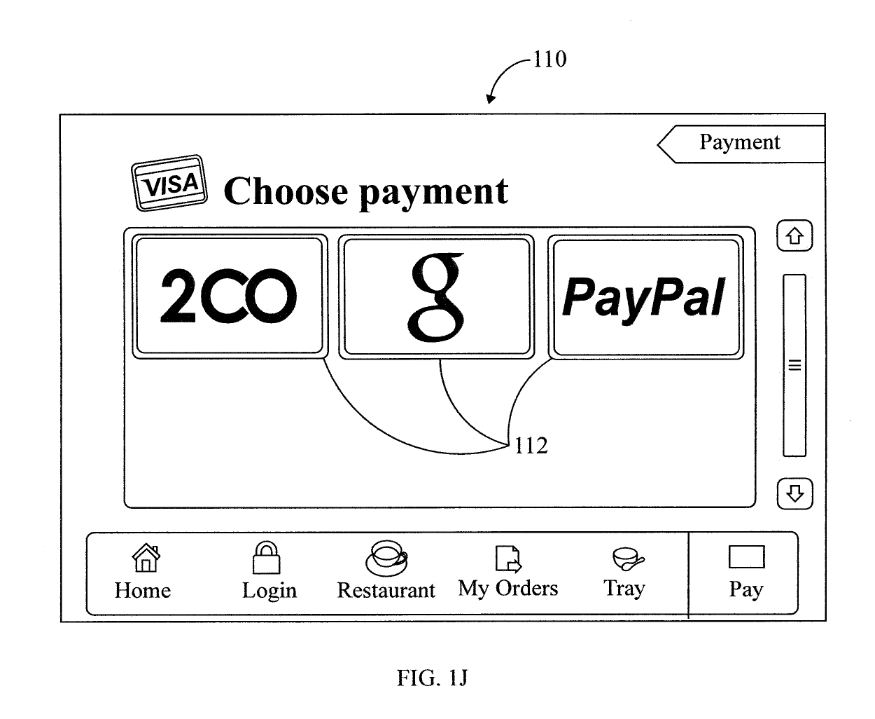

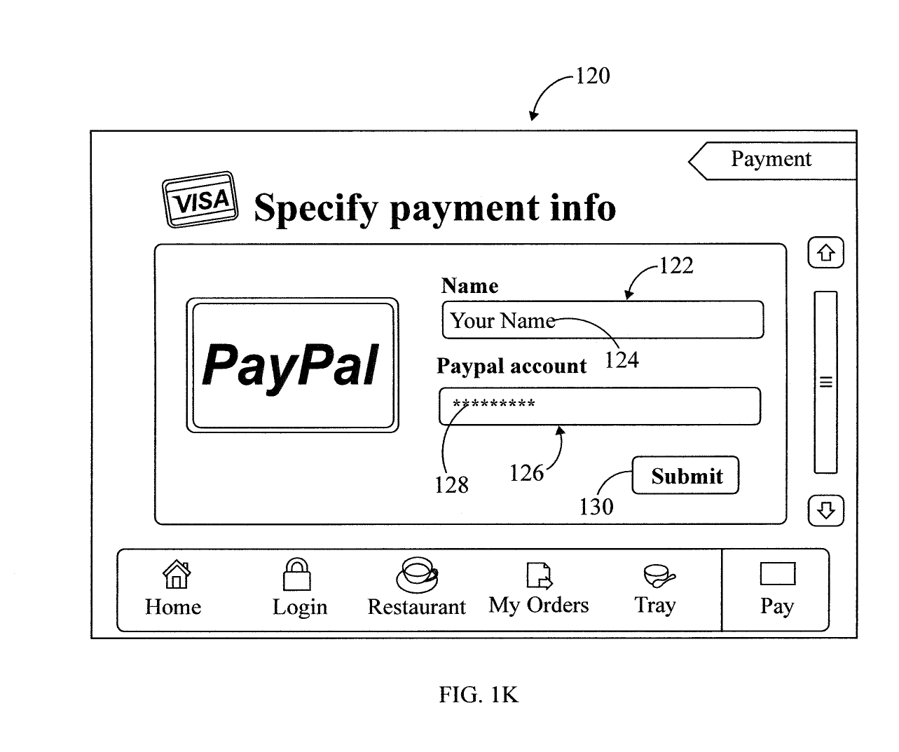

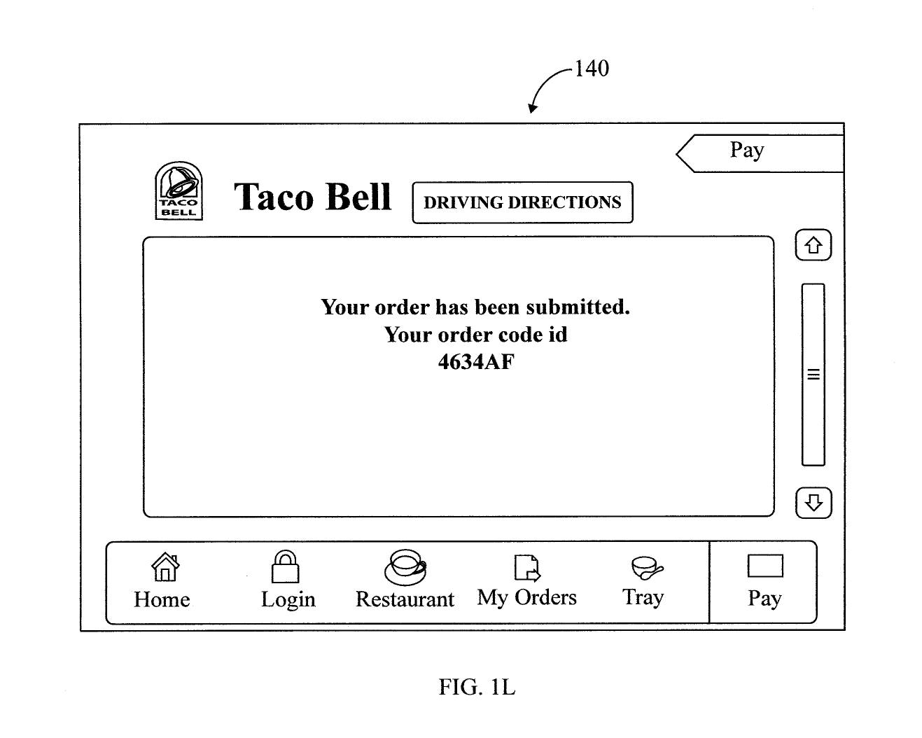

FIG. 1A shows a screen shot of a login page for accessing an Internet enabled application 10 via a net enabled motor vehicle associated with a customer. The Internet enabled application for user interface allows interactive communication between a client side and a server side for food ordering and payment online. The at least one means of ordering the item includes a touch screen ordering and voice based ordering. The login page 10 includes a first box 12 to enter a username 14 and a second box 16 to enter a password 18. At least one customer having an account can access the Internet enabled application by entering the username 14 and the password 18 and the at least one customer can press the log in button 20 to access the Internet enabled application. At least one new customer can create an account by using a “Create an account button” 22. Activating a “Remember me” button 24 will automatically save the username 14 and the password 18 and the at least one customer can automatically log on to the account.

FIG. 1B shows the screen shot of a home page of the Internet enabled application 30. When the at least one customer log on to the application a welcoming message 32 for greeting the at least one customer is displayed on a screen of at least one in-car computing electronic device. In another aspect of the invention, the Internet enabled application may be operated on at least one electronic device selected from a group consisting of smart phones, tablets, and other mobile devices.

FIG. 1C shows the screen shot that displays name of at least one restaurant 40. The at least one customer can select at least one restaurant from the list of at least one restaurant 42 displayed in the screen. Also the at least one customer have the provision to search for at least one restaurant proximate and/or within a range to a current customer location. FIG. 1D shows the screen shot displaying driving direction of at least one restaurant near to the current location of at least one customer 50. The driving direction helps the at least one customer to easily find the position of the at least one restaurant.

FIG. 1E shows the screen shot displaying locations of at least one restaurant 60. The at least one customer is able to know the distance of the at least one restaurant from the current location. FIG. 1F shows the screen shot displaying name, location and address of at least one restaurant selected by the at least one customer 70. A place order button 72 is employed to navigate to an order page 80 and a get direction button 74 to redirect to the driving direction 50. FIG. 1G shows the screen shot displaying a list of at least one item from an available menu options of the at least one restaurant 80. The at least one customer can add 82 the at least one selected item and cancel 84 if not needed. After selecting the at least one item the at least one customer can confirm the order by selecting an order complete button 86 and cancel the order by selecting a cancel button 88. FIG. 1H shows the screen shot displaying the at least one restaurant selected by the at least one customer and the amount to be paid for the at least one item 90. The at least one customer has the option to view Previous orders 92 and to add favorite items to Favorites 94. FIG. 1I shows the' screen shot in which the at least one customer can add a payment type, a mail id or a telephone number 100. FIG. 1J shows the screen shot displaying a plurality of payment options 110 and the customer can select a payment mode 112 from the plurality of payment options. The mode of payment of the at least one item can be selected from a group consisting of credit card, debit card or cash.

FIG. 1K shows the screen shot displaying the payment mode selected by the at least one customer 120. A name field 122 for entering a username 124 and an account field 126 for entering an account number 128 is also present. A submit button 130 is present to submit the payment for the ordered item. FIG. 1L shows the screen shot displaying an order code for purchasing the at least one item selected by the at least one customer 300.

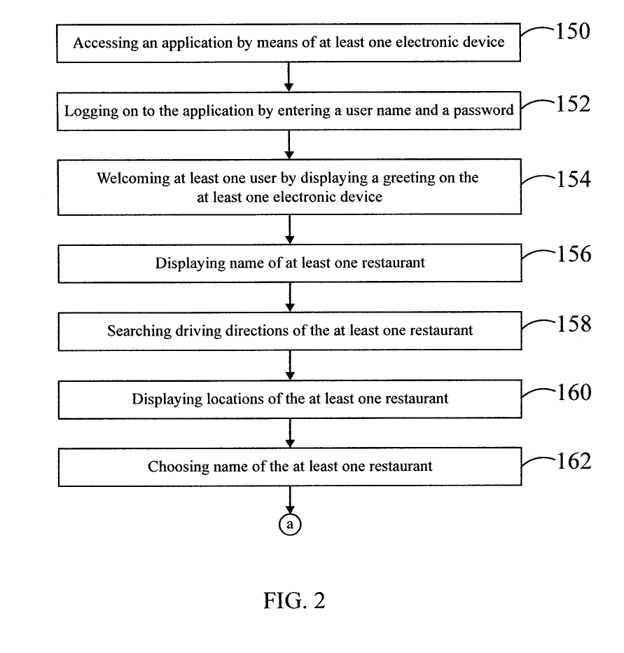

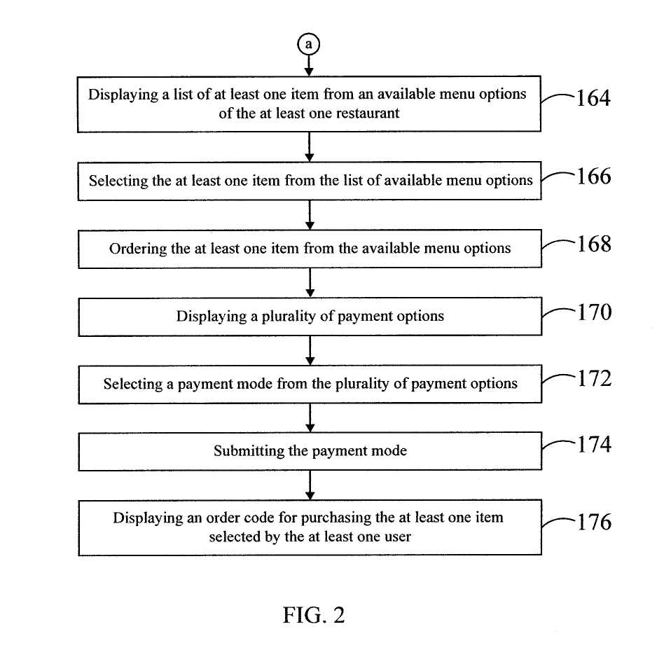

FIG. 2 shows a flow chart illustrating a method for ordering and payment of food through the Internet enabled application. The method is initiated by accessing an application by means of at least one electronic device as shown in block 150. Then log on to the application by entering a username and a password as indicated at block 152. Then a greeting for welcoming at least one customer is displayed on the at least one electronic device as shown in block 154. Then, name of at least one restaurant is displayed on the screen as shown in block 156. Thereafter the at least one customer can search for driving directions of the at least one restaurant as indicated at block 158. As shown in block 160 the location of at least one restaurant is displayed on the screen. The customer can choose name of the at least one restaurant as indicated at block 162. As shown in block 164 a list of at least one item from an available menu options is displayed on the screen. The at least one customer can select the at least one item from the list of available menu options as shown in block 166. Then as indicated at block 168 the at least one customer can order the at least one item from the available menu options. A plurality of payment options is displayed on the screen as indicated at block 170. The at least one customer selects a payment mode from the plurality of payment options as shown in block 172. Thereafter the at least one customer submits the payment mode as shown in block 174 and finally, displaying an order code for purchasing the at least one item selected by the at least one customer as indicated at block 176.

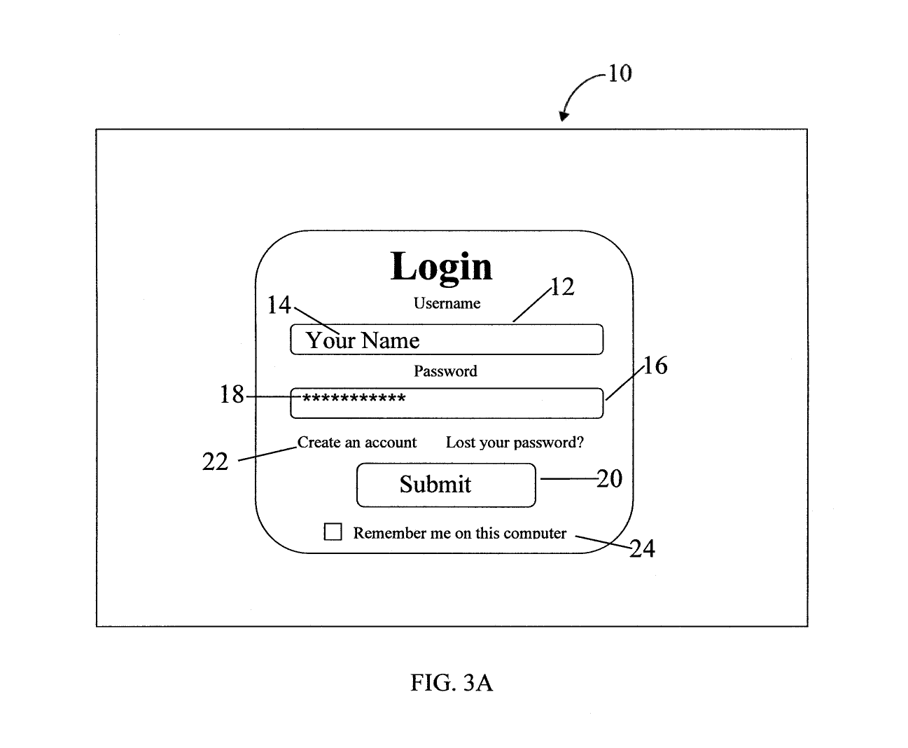

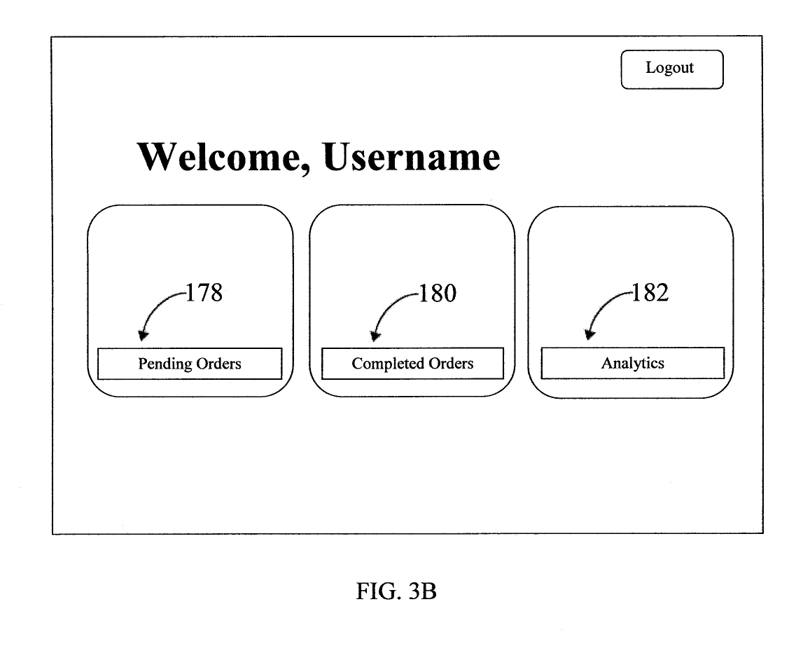

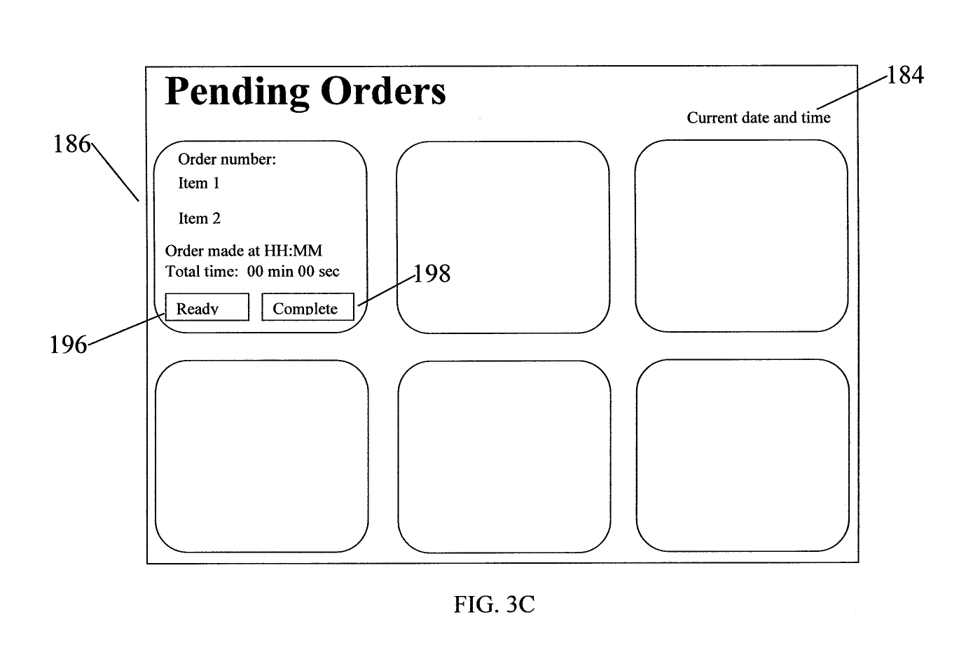

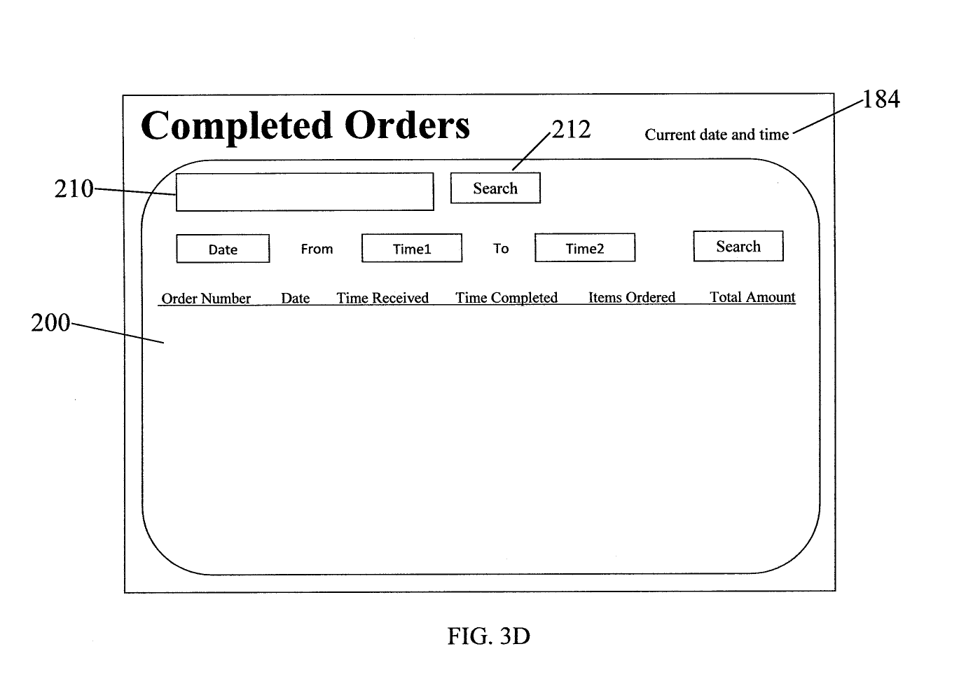

FIG. 3A illustrates a point of sale terminal displaying a login page of the Internet enabled application associated with a service provider in accordance with the preferred embodiment of the present invention. The Internet enabled application for user interface allows interactive communication between a client side and a server side for retrieving pending orders to be completed by the at least one service provider. The login page 10 includes a first box 12 to enter a username 14 and a second box 16 to enter a password 18. At least one service provider having an account can access the Internet enabled application by entering the username 14 and the password 18 and the at least one service provider can press the Submit button 20 to access the Internet enabled application. At least one new service provider employee can create an account by using a “Create an account” button 22. Activating a “Remember me on this computer” button 24 will automatically save the username 14 and the password 18 and the at least one service provider can automatically log on to the account.

FIG. 3B shows the screen shot of a service provider home page of the Internet enabled application. When the at least one service provider logs on to the application a welcome page. The at least one service provider can select to view pending orders 178, completed orders 180, or analytics 182.

FIG. 3C shows the pending orders page of the Internet enabled application. The screen shot displays current date and time 184 and pending order information 186. The at least one service provider will be able to view order number 188, items ordered 190, order submission time 192, and length of the order has been pending 194. The at least one service provider selects the ready button 196 when the order is ready to be picked up. When the order has been picked up the at least one service provider selects the complete button 198.

FIG. 3D shows the completed orders page of the Internet enabled application. The screen shot displays current date and time 184 and a list of completed orders 200. The at least one service provider will be able to view order numbers 188, order date 202, time received 204, time completed 206, items ordered 190, and total order amount 208. The completed orders page also includes a search box 210 and search button 212 which allows the at least one service provider to search for specific orders.

The foregoing description of the preferred embodiment of the present invention has been presented for the purpose of illustration and description. It is not intended to be exhaustive or to limit the invention to the precise form disclosed. Many modifications and variations are possible in light of the above teachings. It is intended that the scope of the present invention not be limited by this detailed description, but by the claims and the equivalents to the claims appended hereto.

What is claimed is:

1. An interactive food ordering and payment system for allowing interactive communication between a client side and a server side comprising:
an Internet enabled application for user interface, the application comprising:
a means for allowing at least one customer to log-on to the application, the log-on permits the at least one user to enter a username and a password;
a means for displaying at least one restaurant proximate and/or within a range to a current user location;
at least one means for ordering at least one item from an available menu options;
a means for selecting a payment mode from a plurality of payment options; and
a means for submitting the payment mode and displaying an order code for purchasing the selected item;
whereby the user interface allows the at least one user to search for the at least one restaurant, select from the available menu options, order for the at least one item and pay for the at least one item through online.

2. The system of claim 1 wherein the application runs on at least one in-car computing electronic device in an Internet enabled vehicle.

3. The system of claim 2 wherein the electronic device may be integrated into the instrument panel of the vehicle.

4. The system of claim 2 wherein the electronic device may be a mobile device selected from a group consisting of: smart phones, tablets, or other mobile devices.

5. The system of claim 1 wherein customization of restaurant chain is achieved by the application.

6. The system of claim 1 wherein a new user can create an account by means of a create an account button.

7. The system of claim 1 wherein the at least one means of ordering the item includes a voice based ordering.

8. The system of claim 1 wherein the at least one means of ordering the item includes a touch screen ordering.

9. An interactive method for food ordering and payment, the method comprising the steps of:
(a) accessing an application by means of at least one in-car computing electronic device;
(b) logging on to the application by entering a username and a password;
(c) welcoming at least one user by displaying a greeting on the at least one electronic device;
(d) displaying name of at least one restaurant;
(e) searching driving directions of the at least one restaurant;
(f) displaying locations of the at least one restaurant;
(g) choosing name of the at least one restaurant;
(h) displaying a list of at least one item from an available menu options of the at least one restaurant;
(i) selecting at least one item from the list of available menu options;
(j) ordering the at least one item from the available menu options;
(k) displaying a plurality of payment options;
(l) selecting a payment mode from the plurality of payment options;
(m) submitting the payment; and
(n) displaying an order code for purchasing the at least one item selected by the at least one user.

10. The method of claim 9 wherein the application allows the at least one user to search for the at least one restaurant, select from the available menu options, order for the item and pay for the item through online.

11. The method of claim 9 wherein the application runs on at least one in-car computing electronic device in an Internet enabled vehicle.

12. The method of claim 11 wherein the application runs on at least one mobile electronic device selected from a group consisting of: smart phones, handheld tablets, or other mobile devices.

13. The method of claim 9 wherein the at least one means of ordering includes a voice based ordering.

14. The method of claim 9 wherein the at least one means of ordering includes a touch screen ordering.

15. The method of claim 9 wherein the mode of payment of the at least one item can be selected from a group consisting of: credit card, debit card or cash.

16. An interactive food ordering and payment system for allowing interactive communication between a client side and a server side comprising:
an Internet enabled application for user interface, the application comprising:
a means for allowing at least one service provider to log-on to the application, the log-on permits the at least one user to enter a username and a password;
a means for displaying pending orders;
at least one means for updating status of pending orders;
a means for viewing completed orders; and
a means for tracking and monitoring order completion performance.

17. The system of claim 16 wherein the application runs on at least one point of sale terminal device.

18. The system of claim 16 wherein a new user can create an account by means of a create an account button.
